(19) United States
(12) Patent Application Publication
(10) Pub. No.: US 2009/0086073 A1
(43) Pub. Date: Apr. 2, 2009

(54) IMAGING APPARATUS AND METHOD OF DRIVING SOLID-STATE IMAGING DEVICE

(76) Inventor: Hirokazu Kobayashi, Saitama (JP)

Correspondence Address: BIRCH STEWART KOLASCH & BIRCH, PO BOX 747, FALLS CHURCH, VA, 22040-0747, US

(21) Appl. No.: 12/236,911

(22) Filed: Sep. 24, 2008

(30) Foreign Application Priority Data
Sep. 27, 2007 (JP) P2007-252600

(51) Int. Cl. H04N 5/335

(52) U.S. Cl. 348/302; 348/E05.091

(57) ABSTRACT

A solid-state imaging device 5 includes photoelectric conversion elements 51R, 51G, and 51B and photoelectric conversion elements 51r, 51g, and 51b there are controlled to have an exposure time shorter than that of the photoelectric conversion elements 51R, 51G, and 51B. During the exposure period of the photoelectric conversion elements 51R, 51G, and 51B, an imaging device driving section 10 applies a readout pulse to transfer electrodes V2 and V6 and applies a suppression pulse having a polarity opposite to that of the readout pulse to transfer electrodes V4 and V8, to thereby read out the charges stored in the photoelectric conversion elements 51r, 51g, and 51b to a vertical charge transfer path 54 and to control start of exposure of the photoelectric conversion elements 51r, 51g, and 51b.

### CROSS-REFERENCE TO RELATED APPLICATIONS

This application is based upon and claims the benefit of priority from the Japanese Patent Application No. 2007-252600 filed on Sep. 27, 2007, the entire contents of which are incorporated herein by reference.

### BACKGROUND OF THE INVENTION

1. Technical Field

The invention relates to an imaging apparatus including a solid-state imaging device and a driving unit that drives the solid-state imaging device.

2. Description of the Related Art

Solid-state imaging devices have been proposed which include high-sensitivity photoelectric conversion elements and low-sensitivity photoelectric conversion elements in order to obtain low-sensitivity image data and high-sensitivity image data by a single imaging operation and to synthesize the obtained image data to thereby widen a dynamic range. There are various methods of making a difference in sensitivity between the photoelectric conversion elements. For example, JP 2001-275044 A (corresponding to U.S. Pat. No. 7,030,923) discloses a method of making a difference in exposure time between the photoelectric conversion elements to obtain the resolution difference.

In JP 2001-275044 A, in order to make the difference in exposure time between the photoelectric conversion elements, during an exposure period of some of the photoelectric conversion elements, a readout pulse is applied to the other photoelectric conversion elements to read out charges stored in the photoelectric conversion elements, thereby controlling the exposure time of the other photoelectric conversion elements. When the charges are read out from the photoelectric conversion elements after the exposure time has elapsed, since the imaging operation has been completed, an image quality is hardly affected by the readout of the charges. However, it is necessary to completely read out the charges during a charge read-out operation for controlling the exposure time in order to prevent occurrence of an afterimage.

### SUMMARY OF THE INVENTION

In view of the above circumstances, the invention has been made and provides an imaging apparatus capable of completely reading out charges when an operation of reading out the charges from the photoelectric conversion elements is performed for controlling an exposure time of photoelectric conversion elements.

According to an aspect of the invention, an imaging apparatus includes a solid-state imaging device and a driving unit that drives the solid-state imaging device. The solid-state imaging device includes a plurality of photoelectric conversion elements, a plurality of charge transfer paths and transfer electrodes. The plurality of photoelectric conversion elements are two-dimensionally arranged on a semiconductor substrate in a specific direction and a direction that is orthogonal to the specific direction. The plurality of charge transfer paths are provided so as to correspond to photoelectric conversion element columns, each including the photoelectric conversion elements arranged in the specific direction. The charge transfer paths transfer in the specific direction charges generated in the plurality of photoelectric conversion elements. The transfer electrodes are provided above the charge transfer paths and are arranged along the specific direction. The transfer electrodes include first transfer electrodes that are provided to correspond to the respective photoelectric conversion elements constituting the photoelectric conversion element column. The first transfer electrodes control reading out of the charges from the photoelectric conversion elements to the charge transfer paths and the transferring of the charges in the charge transfer path. The plurality of photoelectric conversion elements include first photoelectric conversion elements and second photoelectric conversion elements. An exposure time of the second photoelectric conversion elements is shorter than that of the first photoelectric conversion elements. During the exposure period of the first photoelectric conversion elements, the driving unit performs a driving operation including applying, to the first transfer electrodes corresponding to the second photoelectric conversion elements, a readout pulse for reading out the charges stored in the photoelectric conversion elements to the charge transfer paths, and applying, to at least a part of the transfer electrodes other than the transfer electrode to which the readout pulse is applied, a suppression pulse that has a polarity opposite to that of the readout pulse and prevents potentials of charge storage regions of the photoelectric conversion elements from changing due to the readout pulse.

In the imaging apparatus, when the exposure time of the second photoelectric conversion elements is equal to or shorter than a threshold value, the driving unit may perform the driving operation. When the exposure time of the second photoelectric conversion elements is longer than the threshold value, the driving unit may classify the first transfer electrodes corresponding to the second photoelectric conversion elements into a plurality of groups and apply the readout pulse and the suppression pulse to the plurality of groups at different timings.

Also, in the imaging apparatus, when the exposure time of the second photoelectric conversion elements is longer than a threshold value, the driving unit may classify the first transfer electrodes corresponding to the second photoelectric conversion elements into a plurality of groups and apply the readout pulse and the suppression pulse to the plurality of groups at different timings. When the exposure time of the second photoelectric conversion elements is equal to or shorter than the threshold value, the driving unit may stop the applying of the suppression pulse during the driving operation and set a level of the readout pulse to be higher than that of the readout pulse, which is applied when the exposure time of the second photoelectric conversion elements is longer than the threshold value.

Also, in the imaging apparatus, a timing at which it is started to apply the suppression pulse may match a timing at which it is started to apply the readout pulse.

Also, in the imaging apparatus, applicable to each transfer electrode may be a first transfer pulse, which has a level that is lower than that of the readout pulse and forms a packet for storing the charge in each charge transfer path, and a second transfer pulse, which has a level that is lower than that of the first transfer pulse and forms a barrier against the packet in each charge transfer path. The driving unit may apply the second transfer pulse to all the transfer electrodes during at least a portion of a period from a start of the exposure time of the first photoelectric conversion elements to the applying of the readout pulse.

According to another aspect of the invention, an imaging apparatus includes a solid-state imaging device and a driving unit that drives the solid-state imaging device. The solid-state imaging device includes a plurality of photoelectric conversion elements, a plurality of charge transfer paths and transfer electrodes. The plurality of photoelectric conversion elements are two-dimensionally arranged on a semiconductor substrate in a specific direction and a direction that is orthogonal to the specific direction. The plurality of charge transfer paths are provided so as to correspond to photoelectric conversion element columns, each including the photoelectric conversion elements arranged in the specific direction. The charge transfer paths transfer in the specific direction charges generated in the plurality of photoelectric conversion elements. The transfer electrodes are provided above the charge transfer paths and are arranged along the specific direction. The transfer electrodes include first transfer electrodes that are provided to correspond to the respective photoelectric conversion elements constituting the photoelectric conversion element column. The first transfer electrodes control reading out of the charges from the photoelectric conversion elements to the charge transfer paths and the transferring of the charges in the charge transfer path. The plurality of photoelectric conversion elements include first photoelectric conversion elements and second photoelectric conversion elements. An exposure time of the second photoelectric conversion elements is shorter than that of the first photoelectric conversion elements. When the exposure time of the second photoelectric conversion elements is longer than a threshold value, during the exposure period of the first photoelectric conversion elements, the driving unit classifies the first transfer electrodes corresponding to the second photoelectric conversion elements into a plurality of groups and applies a first readout pulse for reading out the charges stored in the photoelectric conversion elements to the charge transfer paths to the plurality of groups at different timings. When the exposure time of the second photoelectric conversion elements is equal to or shorter than the threshold value, during the exposure period of the first photoelectric conversion elements, the driving unit applies a second readout pulse having a level that is higher than that of the first readout pulse to the first transfer electrodes corresponding to the second photoelectric conversion elements.

In the imaging apparatus, applicable to each transfer electrode may be a first transfer pulse, which has a level that is lower than that of the readout pulse and forms a packet for storing the charge in each charge transfer path, and a second transfer pulse, which has a level that is lower than that of the first transfer pulse and forms a barrier against the packet in each charge transfer path. The driving unit may apply the second transfer pulse to all the transfer electrodes during at least a portion of a period from a start of the exposure time of the first photoelectric conversion elements to the applying of the readout pulse.

According to further another aspect of the invention, a solid-state imaging device includes a plurality of photoelectric conversion elements, a plurality of charge transfer paths and transfer electrodes. The plurality of photoelectric conversion elements are two-dimensionally arranged on a semiconductor substrate in a specific direction and a direction that is orthogonal to the specific direction. The plurality of charge transfer paths are provided so as to correspond to photoelectric conversion element columns, each including the photoelectric conversion elements arranged in the specific direction. The charge transfer paths transfer in the specific direction charges generated in the plurality of photoelectric conversion elements. The transfer electrodes are provided above the charge transfer paths and are arranged along the specific direction. The transfer electrodes include first transfer electrodes that are provided to correspond to the respective photoelectric conversion elements constituting the photoelectric conversion element column. The first transfer electrodes control reading out of the charges from the photoelectric conversion elements to the charge transfer paths and the transferring of the charges in the charge transfer path. The plurality of photoelectric conversion elements include first photoelectric conversion elements and second photoelectric conversion elements. An exposure time of the second photoelectric conversion elements is shorter than that of the first photoelectric conversion elements. A method of driving the solid-state imaging device includes, during the exposure period of the first photoelectric conversion elements, applying, to the first transfer electrodes corresponding to the second photoelectric conversion elements, a readout pulse for reading out the charges stored in the photoelectric conversion elements to the charge transfer paths, and applying, to at least a part of the transfer electrodes other than the transfer electrode to which the readout pulse is applied, a suppression pulse that has a polarity opposite to that of the readout pulse and prevents potentials of charge storage regions of the photoelectric conversion elements from changing due to the readout pulse.

The method may further include comparing the exposure time of the second photoelectric conversion elements with a threshold value. When the exposure time of the second photoelectric conversion elements is equal to or shorter than the threshold value, the applying of the readout pulse and the applying of the suppression pulse may be performed. When the exposure time of the second photoelectric conversion elements is longer than the threshold value, the first transfer electrodes corresponding to the second photoelectric conversion elements may be classified into a plurality of groups, and the readout pulse and the suppression pulse may be applied to the plurality of groups at different timings.

Also, the method may further include comparing the exposure time of the second photoelectric conversion elements with a threshold value. When the exposure time of the second photoelectric conversion elements is longer than the threshold value, the first transfer electrodes corresponding to the second photoelectric conversion elements may be classified into a plurality of groups, and the readout pulse and the suppression pulse may be applied to the plurality of groups at different timings. When the exposure time of the second photoelectric conversion elements is equal to or shorter than the threshold value, the applying of the suppression pulse may be stopped, and a level of the readout pulse may be set to be higher than that of the readout pulse, which is applied when the exposure time of the second photoelectric conversion elements is longer than the threshold value.

Also, in the method, a timing at which it is started to apply the suppression pulse may match a timing at which it is started to apply the readout pulse.

Also, in the method, applicable to each transfer electrode may be a first transfer pulse, which has a level that is lower than that of the readout pulse and forms a packet for storing the charge in each charge transfer path, and a second transfer pulse, which has a level that is lower than that of the first transfer pulse and forms a barrier against the packet in each charge transfer path. The method may further include applying the second transfer pulse to all the transfer electrodes during at least a portion of a period from a start of the exposure time of the first photoelectric conversion elements to the applying of the readout pulse.

According to still another aspect of the invention, a solid-state imaging device includes a plurality of photoelectric conversion elements, a plurality of charge transfer paths and transfer electrodes. The plurality of photoelectric conversion elements are two-dimensionally arranged on a semiconductor substrate in a specific direction and a direction that is orthogonal to the specific direction. The plurality of charge transfer paths are provided so as to correspond to photoelectric conversion element columns, each including the photoelectric conversion elements arranged in the specific direction. The charge transfer paths transfer in the specific direction charges generated in the plurality of photoelectric conversion elements. The transfer electrodes are provided above the charge transfer paths and are arranged along the specific direction. The transfer electrodes include first transfer electrodes that are provided to correspond to the respective photoelectric conversion elements constituting the photoelectric conversion element column. The first transfer electrodes control reading out of the charges from the photoelectric conversion elements to the charge transfer paths and the transferring of the charges in the charge transfer path. The plurality of photoelectric conversion elements include first photoelectric conversion elements and second photoelectric conversion elements. An exposure time of the second photoelectric conversion elements is shorter than that of the first photoelectric conversion elements. A method of driving the solid-state imaging device includes: comparing the exposure time of the second photoelectric conversion elements with a threshold value; when the exposure time of the second photoelectric conversion elements is longer than the threshold value, during the exposure period of the first photoelectric conversion elements, classifying the first transfer electrodes corresponding to the second photoelectric conversion elements into a plurality of groups, and applying a first readout pulse for reading out the charges stored in the photoelectric conversion elements to the charge transfer paths to the plurality of groups at different timings; and when the exposure time of the second photoelectric conversion elements is equal to or shorter than the threshold value, during the exposure period of the first photoelectric conversion elements, applying a second readout pulse having a level that is higher than that of the first readout pulse to the first transfer electrodes corresponding to the second photoelectric conversion elements.

In the method, applicable to each transfer electrode may be a first transfer pulse, which has a level that is lower than that of the readout pulse and forms a packet for storing the charge in each charge transfer path, and a second transfer pulse, which has a level that is lower than that of the first transfer pulse and forms a barrier against the packet in each charge transfer path. The method may further include applying the second transfer pulse to all the transfer electrodes during at least a portion of a period from a start of the exposure time of the first photoelectric conversion elements to the applying of the readout pulse.

With the above configuration, it is possible to provide an imaging apparatus capable of completely reading out charges when an operation of reading out the charges from photoelectric conversion elements is performed for controlling an exposure time of the photoelectric conversion elements.

### BRIEF DESCRIPTION OF THE DRAWINGS

FIG. 1 is a diagram schematically illustrating the configuration of a digital camera, which is an example of an imaging apparatus, according to a first embodiment of the invention.

FIG. 2 is a plan view schematically illustrating an example of the structure of a solid-state imaging device provided in the digital camera according to the first embodiment of the invention.

FIG. 3 is a timing chart of transfer pulses during an imaging operation of the digital camera according to the first embodiment of the invention.

FIG. 4 is a plan view schematically illustrating another example of the structure of the solid-state imaging device provided in the digital camera shown in FIG. 1.

FIG. 5 is a plan view schematically illustrating still another example of the structure of the solid-state imaging device provided in the digital camera shown in FIG. 1.

FIG. 6 is a flowchart of an imaging operation of a digital camera according to a third embodiment of the invention.

FIG. 7 is a timing chart of transfer pulses during the imaging operation of the digital camera according to the third embodiment of the invention.

FIG. 8 is a flowchart of an imaging operation of a digital camera according to a fourth embodiment of the invention.

FIG. 9 is a timing chart of transfer pulses during the imaging operation of the digital camera according to the fourth embodiment of the invention.

### DETAILED DESCRIPTION OF EMBODIMENTS OF THE INVENTION

Hereinafter, exemplary embodiments of the invention will be described with reference to the accompanying drawings.

### First Embodiment

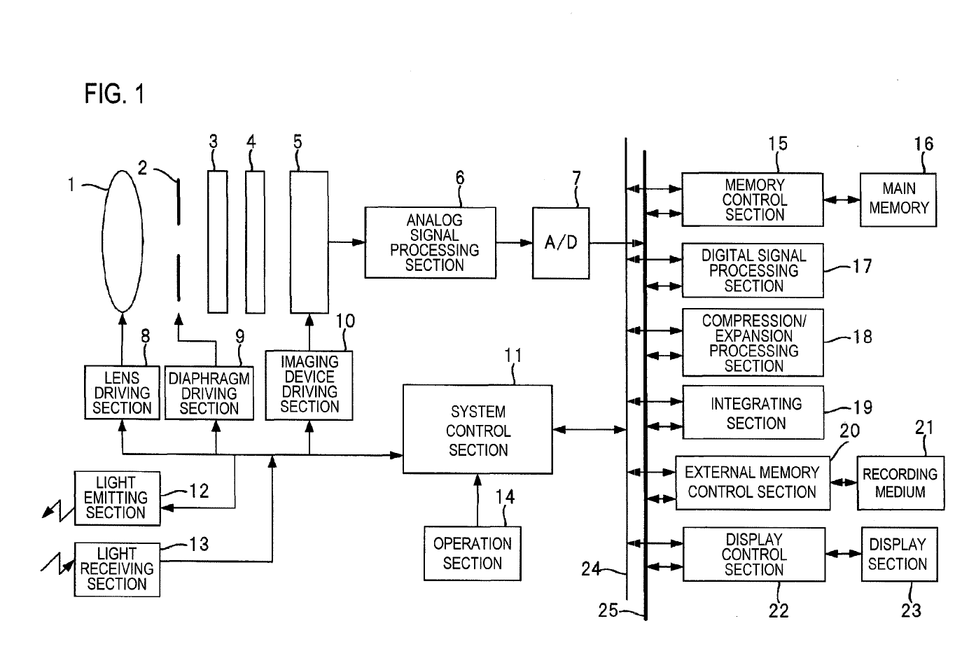

FIG. 1 is a diagram schematically illustrating the configuration of a digital camera, which is an example of an imaging apparatus, according to a first embodiment of the invention.

An imaging system of the digital camera shown in FIG. 1 includes an imaging lens 1, a solid-state imaging device 5, an aperture diaphragm 2 that is provided between the imaging lens 1 and the solid-state imaging device 5, an infrared cut filter 3, and an optical low pass filter 4.

A system control section 11 that controls the overall operation of an electric control system of the digital camera controls a flash light emitting section 12 and a light receiving section 13, controls a lens driving section 8 to adjust a position of the imaging lens 1 to a focusing position or to perform a zoom adjustment, and controls a diaphragm driving section 9 to adjust an aperture amount of the aperture diaphragm 2, thereby adjusting an amount of exposure light.

Further, the system control section 11 drive the solid-state imaging device 5 through an imaging device driving section 10 and to output an image captured through the imaging lens 1 as color signals. A command signal from a user is input to the system control section 11 through an operation section 14.

Furthermore, the electric control system of the digital camera includes: an analog signal processing section 6 that is connected to an output terminal of the solid-state imaging device 5 and performs analog signal processing, such as correlation double sampling processing; and an A/D conversion circuit 7 that converts RGB color signals that are output from the analog signal processing section 6 into digital signals. The analog signal processing section 6 and the A/D conversion circuit 7 are controlled by the system control section 11.

Moreover, the electric control system of the digital camera includes: a main memory 16; a memory control section 15 that is connected to the main memory 16; a digital signal processing section 17 that performs, for example an interpolating operation, a gamma correction operation, an RGB/YC conversion process, and an image synthesizing process to generate image data; a compression/expansion processing section 18 that compresses the image data generated by the digital signal processing section 17 in a JPEG format or expands the compressed image data; an integrating section 19 that integrates photometric data and calculates a gain of white balance correction performed by the digital signal processing section 17; an external memory control section 20 to which a detachable recording medium 21 is connected; and a display control section 22 that is connected to a liquid crystal display section 23 mounted on the rear surface of the camera. These components described above are connected to one another by a control bus 24 and a data bus 25 and are controlled based on commands from the system control section 11.

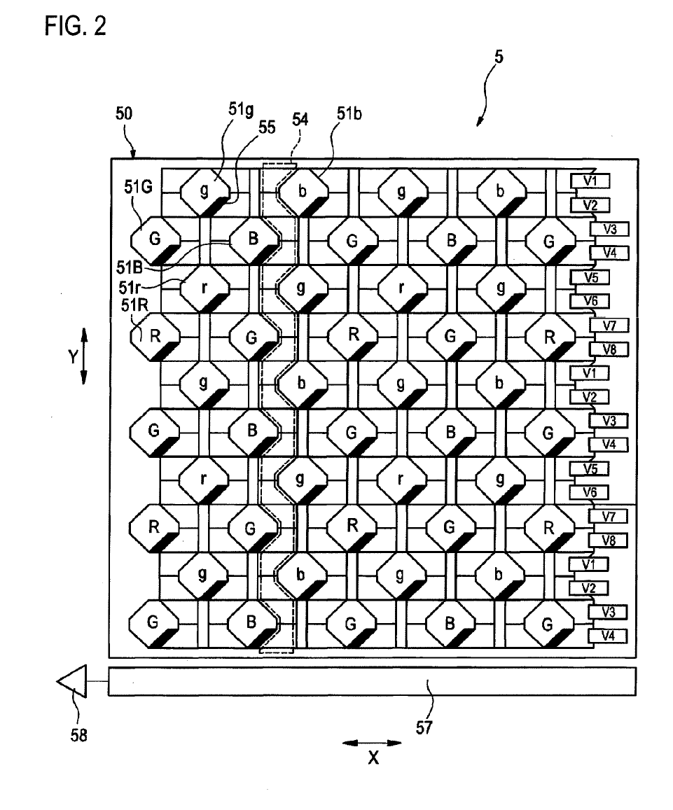

FIG. 2 is a plan view schematically illustrating an example of the structure of the solid-state imaging device 5 shown in FIG. 1.

The solid-state imaging device 5 includes an RGB group of photoelectric conversion elements and an rgb group of photoelectric conversion elements. The RGB group includes photoelectric conversion elements 51R (which is represented by ‘R’ in FIG. 2) that detects light (R light) in a red (R) wavelength range, photoelectric conversion elements 51G (which is represented by ‘G’ in FIG. 2) that detects light (G light) in a green (G) wavelength range, and photoelectric conversion elements 51B (which is represented by ‘B’ in FIG. 2) that detects light (B light) in a blue (B) wavelength range. The photoelectric conversion elements 51R, 51G, 51B are arranged in a square lattice on a semiconductor substrate 50 in a row direction X and in a column direction Y that is perpendicular to the row direction X. The rgb group includes photoelectric conversion elements 51r (which is represented by ‘r’ in FIG. 2) that detects the R light, photoelectric conversion elements 51g (which is represented by ‘g’ in FIG. 2) that detects the G light, and photoelectric conversion elements 51b (which is represented by ‘b’ in FIG. 2) that detects the B light. The photoelectric conversion elements 51r, 51g, 51b are arranged in a square lattice on the semiconductor substrate 50 in the row direction X and in the column direction Y being perpendicular to the row direction X. The RGB group and the rgb group are shifted in the row direction X and the column direction Y from each other by about half of a pitch between the photoelectric conversion elements.

Color filters are provided above the photoelectric conversion elements of the RGB group so as to be arranged in the Bayer pattern. Similarly, color filters are provided above the photoelectric conversion elements of the rgb group so as to be arranged in the Bayer pattern.

The photoelectric conversion elements of the RGB group and the photoelectric conversion elements of the rgb group have the same structure, but the imaging device driving section 10 controls an exposure time of the RGB group and an exposure time of the rgb group to be different from each other. In this embodiment, the exposure time of the photoelectric conversion elements of the rgb group are set to be shorter than that of the photoelectric conversion elements of the RGB group.

The photoelectric conversion elements of the RGB group are arranged such that a GR photoelectric conversion element column including the photoelectric conversion elements 51G and the photoelectric conversion elements 51R, which are arranged in the column direction Y, and a BG photoelectric conversion element column including the photoelectric conversion elements 51B and the photoelectric conversion elements 51G, which are arranged in the column direction Y, are alternately arranged in the row direction X. Alternatively, it can be said that the photoelectric conversion elements of the RGB group are arranged such that a GB photoelectric conversion element row including the photoelectric conversion elements 51G and the photoelectric conversion elements 51B, which are arranged in the row direction X, and an RG photoelectric conversion element row including the photoelectric conversion elements 51R and the photoelectric conversion elements 51G, which are arranged in the row direction X, are alternately arranged in the column direction Y.

The photoelectric conversion elements of the rgb group are arranged such that a gr photoelectric conversion element column including the photoelectric conversion elements 51g and the photoelectric conversion elements 51r, which are arranged in the column direction Y, and a bg photoelectric conversion element column including the photoelectric conversion elements 51b and the photoelectric conversion elements 51g, which are arranged in the column direction Y, are alternately arranged in the row direction X. Alternatively, it can be said that the photoelectric conversion elements of the rgb group are arranged such that a gb photoelectric conversion element row including the photoelectric conversion elements 51g and the photoelectric conversion elements 51b, which are arranged in the row direction X, and an rg photoelectric conversion element row including the photoelectric conversion elements 51r and the photoelectric conversion elements 51g, which are arranged in the row direction X, are alternately arranged in the column direction Y.

Vertical charge transfer paths 54 (some of them are shown in FIG. 2) are formed on the right side of the respective photoelectric conversion element columns so as to correspond to the respective photoelectric conversion element columns. Each vertical charge transfer path 54 transfers in the column direction Y charges stored in the photoelectric conversion elements constituting the corresponding photoelectric conversion element column. The vertical charge transfer paths 54 are formed of, for example, n-type impurities injected into a p well layer that is formed on an n-type silicon substrate.

Transfer electrodes V1 to V8 are formed above the vertical charge transfer paths 54. The imaging device driving section 10 applies 8-phase transfer pulses for controlling the transfer of charges, which are read out to the vertical charge transfer paths 54, to the transfer electrodes V1 to V8. A transfer pulse φV1 is applied to the transfer electrode V1, a transfer pulse φV2 is applied to the transfer electrode V2, a transfer pulse φV3 is applied to the transfer electrode V3, a transfer pulse φV4 is applied to the transfer electrode V4, a transfer pulse φV5 is applied to the transfer electrode V5, a transfer pulse φV6 is applied to the transfer electrode V6, a transfer pulse φV7 is applied to the transfer electrode V7, and a transfer pulse φV8 is applied to the transfer electrode V8.

The transfer electrodes V1 to V8 are provided in a meandering manner in the row direction X between the photoelectric conversion element rows so as to avoid the photoelectric conversion elements. The transfer electrodes V8 and V1 are arranged on the upper side of the gb photoelectric conversion element row and between the gb photoelectric conversion element rows and adjacent photoelectric conversion element rows, in this order from the adjacent photoelectric conversion element rows. The transfer electrodes V2 and V3 are arranged on the lower side of the gb photoelectric conversion element rows and between the gb photoelectric conversion element rows and adjacent photoelectric conversion element rows, in this order from the gb photoelectric conversion element rows. The transfer electrodes V4 and V5 are arranged on the upper side of the rg photoelectric conversion element rows and between the rg photoelectric conversion element rows and adjacent photoelectric conversion element rows, in this order from the adjacent photoelectric conversion element rows. The transfer electrodes V6 and V7 are arranged on the lower side of the rg photoelectric conversion element rows and between the rg photoelectric conversion element rows and adjacent photoelectric conversion element rows, in this order from the rg photoelectric conversion element rows.

A charge read-out section 55 that reads out the charge generated in each photoelectric conversion element to the corresponding vertical charge transfer path 54 is provided between each photoelectric conversion element and the corresponding vertical change transfer path 54. For example, the change read-out section 55 is formed by a portion of the p well layer that is formed on an n-type silicon substrate. The change read-out sections 55 are provided in the same direction with respect to the photoelectric conversion elements (a lower right direction of each photoelectric conversion element in FIG. 2).

The transfer electrodes V2 are formed above the charge read-out sections 55 corresponding to the photoelectric conversion elements of the gb photoelectric conversion element rows. When a readout pulse is applied to the transfer electrodes V2, the charges stored in the photoelectric conversion elements of the gb photoelectric conversion element rows are read out to the vertical change transfer paths 54, which are arranged on the right side of the photoelectric conversion elements.

The transfer electrodes V4 are formed above the charge read-out sections 55 corresponding to the photoelectric conversion elements of the GB photoelectric conversion element rows. When a readout pulse is applied to the transfer electrodes V4, the charges stored in the photoelectric conversion elements of the GB photoelectric conversion element rows are read out to the vertical change transfer paths 54, which are arranged on the right side of the photoelectric conversion elements.

The transfer electrodes V6 are formed above the charge read-out sections 55 corresponding to the photoelectric conversion elements of the rg photoelectric conversion element rows. When a readout pulse is applied to the transfer electrodes V6, the charges stored in the photoelectric conversion elements of the rg photoelectric conversion element rows are read out to the vertical change transfer paths 54, which are arranged on the right side of the photoelectric conversion elements.

The transfer electrodes V8 are formed above the charge read-out sections 55 corresponding to the photoelectric conversion elements of the RG photoelectric conversion element rows. When a readout pulse is applied to the transfer electrodes V8, the charges stored in the photoelectric conversion elements of the RG photoelectric conversion element rows are read out to the vertical change transfer paths 54, which are arranged on the right side of the photoelectric conversion elements.

A horizontal charge transfer path 57 that transfers the charges transmitted from the vertical charge transfer paths 54 in the row direction X is connected to the vertical charge transfer paths 54. An output amplifier 58 that converts the charges transferred from the horizontal charge transfer path 57 into voltage signals and outputs the voltage signals is connected to the horizontal charge transfer path 57.

Any of (i) a middle-level (VM, for example, 0 V) transfer pulse that forms packets for storing charges in the vertical charge transfer paths 54, (ii) a low-level (VL, for example, −8 V) transfer pulse that forms barriers against the packets in the vertical charge transfer paths 54 and is lower in level than the middle-level transfer pulse, and (iii) a high-level (VH, for example, 15 V) readout pulse that reads out the charges from the photoelectric conversion elements to the vertical charge transfer paths 54 is applicable to the transfer electrodes V2, V4, V6, and V8 provided above the charge read-out sections 55. Any of the transfer pulses VL and VM is applicable to the transfer electrodes V1, V3, V5, and V7, which are provided above the charge read-out sections 55 and other than the transfer electrodes V2, V4, V6, and V8.

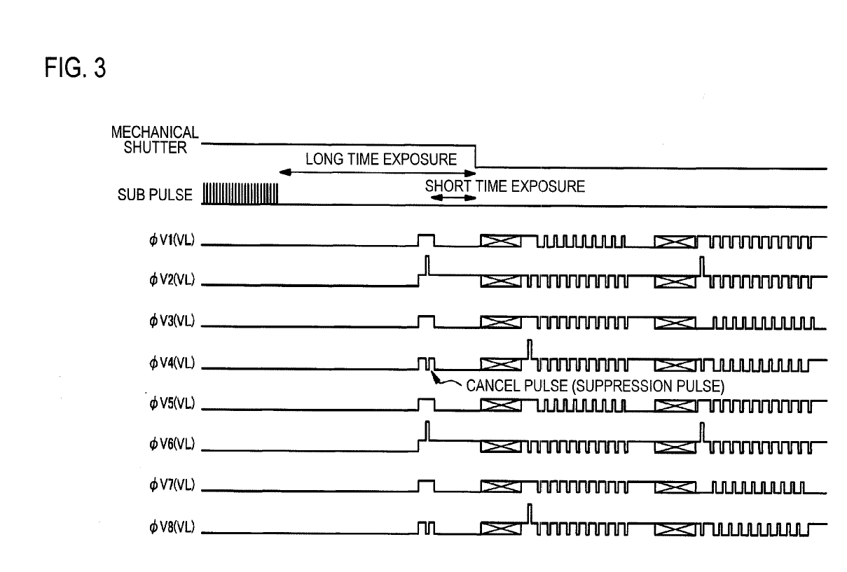

Next, an imaging operation of the digital camera having the above-mentioned structure will be described. FIG. 3 is a timing chart of the transfer pulses during the imaging operation of the digital camera according to the first embodiment.

When a shutter button in the operation section 14 is pressed halfway, the system control section 11 performs the auto exposure (AE) process and the auto focusing (AF) process to measure a dynamic range required to capture an image of a subject. The system control section 11 determines the exposure time of the photoelectric conversion elements 51R, 51G, and 51B and the exposure time of the photoelectric conversion elements 51r, 51g, and 51b based on the measured dynamic range, and controls the imaging device driving section 10 to capture an image for the determined exposure time.

As shown in FIG. 3, when, during a period for which a mechanical shutter (not shown) provided in the digital camera is opened, the imaging device driving section 10 stops supply of an electronic shutter pulse (SUB pulse) so as to open an electronic shutter, the exposure period of the photoelectric conversion elements 51R, 51G, and 51B starts. When the exposure period starts, the low-level (for example, about −8 V) transfer pulse VL is applied from the imaging device driving section 10 to the transfer electrodes V1 to V8.

Immediately before the exposure start timing of the photoelectric conversion elements 51r, 51g, and 51b, the imaging device driving section 10 applies the middle-level (VM, for example, 0 V) transfer pulse to the transfer electrodes V1 to V8. Then, at the exposure start timing of the photoelectric conversion elements 51r, 51g, and 51b, the imaging device driving section 10 applies the high-level (VH, for example, 15 V) readout pulse to the transfer electrodes V2 and V6 to read out the charges stored in the photoelectric conversion elements 51r, 51g, and 51b to the vertical charge transfer paths 54 through the charge read-out sections 55. Upon stop of the supply of the readout pulse VH, the imaging device driving section 10 starts the exposure period of the photoelectric conversion elements 51r, 51g, and 51b.

When the readout pulse is applied, potentials of the charge read-out sections 55 are lowered, and the barriers disappear. Therefore, the charges stored in charge storage regions of the photoelectric conversion elements are read out to the vertical charge transfer paths 54. However, when the read-out voltage is applied, the potentials of the charge storage regions of the photoelectric conversion elements increase, and a minimum depletion voltage tends to increase. That is, when the potential of the charge storage region of the photoelectric conversion element increases, charges are likely to remain in the charge storage region, which makes it difficult to fully transfer the charges. As a result, an afterimage may occur.

In order to fully read out the charges stored in the photoelectric conversion elements 51r, 51g, and 51b to the vertical charge transfer paths 54, an effective voltage of the readout pulse applied to the transfer electrodes V2 and V6 is significant. The effective voltage is determined by a difference between the potential of the transfer electrode to which the readout pulse is applied and the potential of a transfer electrode adjacent to the transfer electrode to which the readout pulse is applied. The effective voltage of about 15 V is required. However, when the read-out voltage is applied to the transfer electrodes V2 and V6, this high-level readout pulse raises the potentials of adjacent transfer electrodes V1, V3, V5, and V7 to be higher than the ground level. As a result, the effective voltage of the readout pulse decreases.

Therefore, in this embodiment, the imaging device driving section 10 applies the readout pulse and concurrently applies a suppression pulse (for example, VL) having a polarity that is opposite to that of the readout pulse to a part of the transfer electrodes (for example, the transfer electrodes V4 and V8) other than the transfer electrodes V2 and V6. When the readout pulse shows change in a positive polarity, the suppression pulse shows change in a negative polarity. The suppression pulse suppresses a potential of the charge storage region from changing due to the readout pulse, thereby reducing the minimum depletion voltage. Since the suppression pulse has a function of decreasing the potential of the photoelectric conversion element (increasing the potential thereof), the charges remaining in the photoelectric conversion element are read out to the vertical charge transfer path 54. If only the readout pulse is applied, a part of the charges would remain. However, since the charges can be fully read out by applying the suppression pulse, the minimum depletion voltage is reduced. Also, the applying of the suppression pulse brings the potential of the transfer electrodes V1, V3, V5, and V7 to be close to the ground level. Therefore, it is possible to set the effective voltage of the readout pulse so as to have a sufficient level for reading out the charges.

The timing of the readout pulse and the timing of the suppression pulse are not necessarily to he exactly identical to each other so long as the readout pulse and the suppression pulse have an overlap period, and the suppression pulse prevents at least a portion of the influence of the readout pulse to show substantially the same charge read-out effect. Also, the suppression pulse may be applied to all the transfer electrodes other than the transfer electrodes to which the readout pulse is applied. The entire contents of JP 2006-54685 A and U.S. Pat. No. 7,052,929 are incorporated herein by reference.

As described above, by applying the readout pulse and the suppression pulse, no charge is accumulated in the photoelectric conversion elements 51r, 51g, and 51b at a time when the exposure of the photoelectric conversion elements 51r, 51g, and 51b starts. Therefore, it is possible to prevent an afterimage.

After applying the readout pulse and the suppression pulse, the imaging device driving section 10 returns the transfer pulses φV2, φV4, φV6, and φV8 to the middle level VM, and then changes the transfer pulses other than the transfer pulses φV2 and φV6 to the low level VL. When the electronic shutter is closed and the exposure time of the photoelectric conversion elements ends, the imaging device driving section 10 controls the transfer pulses to sweep unnecessary charges remaining in the vertical charge transfer path 54 at a high speed. After the sweep of the charge is completed, the imaging device driving section 10 applies the readout pulse to the transfer electrodes V4 and V8 and applies the suppression pulse to the transfer electrodes V2 and V6 to read out the charges stored in the photoelectric conversion elements 51R, 51G, and 51B to the vertical charge transfer paths 54. Thereafter, the imaging device driving section 10 controls the transfer pulses so as to transfer the read charges to the output amplifier 58 through the horizontal charge transfer path 57. In this way, signals corresponding to the charges stored in the photoelectric conversion elements 51R, 51G, and 51B are output from the solid-state imaging device 5.

Next, the imaging device driving section 10 controls the transfer pulses to sweep unnecessary charge remaining in the vertical charge transfer path 54 at a high speed. After the sweep of the charge is completed, the imaging device driving section 10 applies the readout pulse to the transfer electrodes V2 and V6 and applies the suppression pulse to the transfer electrodes V4 and V8 so as to read out the charges stored in the photoelectric conversion elements 51r, 51g, and 51b to the vertical charge transfer paths 54. Thereafter, the imaging device driving section 10 controls the transfer pulses so as to transfer the read charges to the output amplifier 58 through the horizontal charge transfer path 57. In this way, signals corresponding to the charges stored in the photoelectric conversion elements 51r, 51g, and 51b are output from the solid-state imaging device 5.

The digital signal processing section 17 generates image data based on the signals obtained from the photoelectric conversion elements 51R, 51G, and 51B, generates image data based on the signals obtained from the photoelectric conversion elements 51r, 51g, and 51b, synthesizes the two image data to generate synthesized image data having a wide dynamic range, and outputs the synthesized image data to the compression/expansion processing section 18. The compression/expansion processing section 18 compresses the synthesized image data, and the compressed synthesized image data is stored in the recording medium 21. In this way, the imaging operation is completed.

As described above, according to the digital camera of this embodiment, when the readout pulse is applied to make a difference in exposure time between the photoelectric conversion elements 51R, 51G, and 51B and the photoelectric conversion elements 51r, 51g, and 51b, the suppression pulse is applied to at least a part of the transfer electrodes other than the transfer electrodes to which the readout pulse is applied. Therefore, it is possible to fully read out the charges stored in the photoelectric conversion elements 51r, 51g, and 51b, and thus prevent the occurrence of an afterimage due to the charges, which remain in the photoelectric conversion elements 51r, 51g, and 51b when the exposure of the photoelectric conversion elements 51r, 51g, and 51b starts.

Further, according to the above-mentioned driving operation, the low-level (VL) transfer pulse is applied to each of the transfer electrodes V1 to V8 during a portion of the period from the exposure start time of the photoelectric conversion elements 51R, 51G, and 51B to the exposure start time of the photoelectric conversion elements 51r, 51g, and 51b. Therefore, it is possible to accumulate electrons are generated in an interface between (i) a region of the silicon substrate 50, which is provided between the photoelectric conversion elements and the vertical charge transfer paths 54, and (ii) a gate insulating film formed on the silicon substrate 50 in the region during the period, without the electrons being moved to the photoelectric conversion elements 51R, 51G, and 51B. The reason is as follows. When a negative transfer pulse is applied to the transfer electrodes above the region, holes are accumulated in the region, and the holes are recombined with the electrons generated in the interface. Therefore, it is possible to accumulate the electrons in the region. As a result, it is possible to prevent white defects from occurring in the photoelectric conversion elements 51R, 51G, and 51B.

In this embodiment, the low-level (VL) transfer pulse is applied to each of the transfer electrodes V1 to V8 during the portion of the period from the exposure start time of the photoelectric conversion elements 51R, 51G, and 51B to the exposure start time of the photoelectric conversion elements 51r, 51g, and 51b. Therefore, there is a possibility that blooming might occur due to smear charges generated during this period. If the exposure time of the photoelectric conversion elements 51r, 51g, and 51b is not to set to be very short, an amount of smear charges reaches a level, which causes blooming, after the exposure of the photoelectric conversion elements 51r, 51g, and 51b starts. Therefore, the blooming is less likely to occur before the exposure of the photoelectric conversion elements 51r, 51g, and 51b starts. Thus, before the exposure of the photoelectric conversion elements 51r, 51g, and 51b starts, it is effective to apply the low-level (VL) transfer pulse to the transfer electrodes V1 to V8 in order to prevent white defects.

In FIG. 3, the middle-level (VM) transfer pulse is applied to the transfer electrodes V1 to V8 and then, the readout pulse is applied immediately before the exposure of the photoelectric conversion elements 51r, 51g, and 51b starts. However, the middle-level (VM) transfer pulse may be applied to the transfer electrodes to which neither the readout pulse nor the suppression pulse is applied concurrently with the applying of the readout pulse. In this case, it becomes possible to apply the low-level (VL) transfer pulse to the transfer electrodes V1 to V8 during the entire period from the exposure start time of the photoelectric conversion elements 51R, 51G, and 51B to the exposure start time of the photoelectric conversion elements 51r, 51g, and 51b. Therefore, it is possible to improve the effect of preventing white defects.

### Second Embodiment

In the first embodiment, the photoelectric conversion elements of the solid-state imaging device 5 are arranged in a so-called honeycomb arrangement in which the RGB group of photoelectric conversion elements and the rgb group of photoelectric conversion elements are shifted in the row direction X and in the column direction Y from each other by about half of the arrangement pitch. However, the arrangement of the photoelectric conversion elements is not limited thereto. For example, the photoelectric conversion elements may be arranged in a square arrangement. In this embodiment, another example of the structure of the solid-state imaging device will be described.

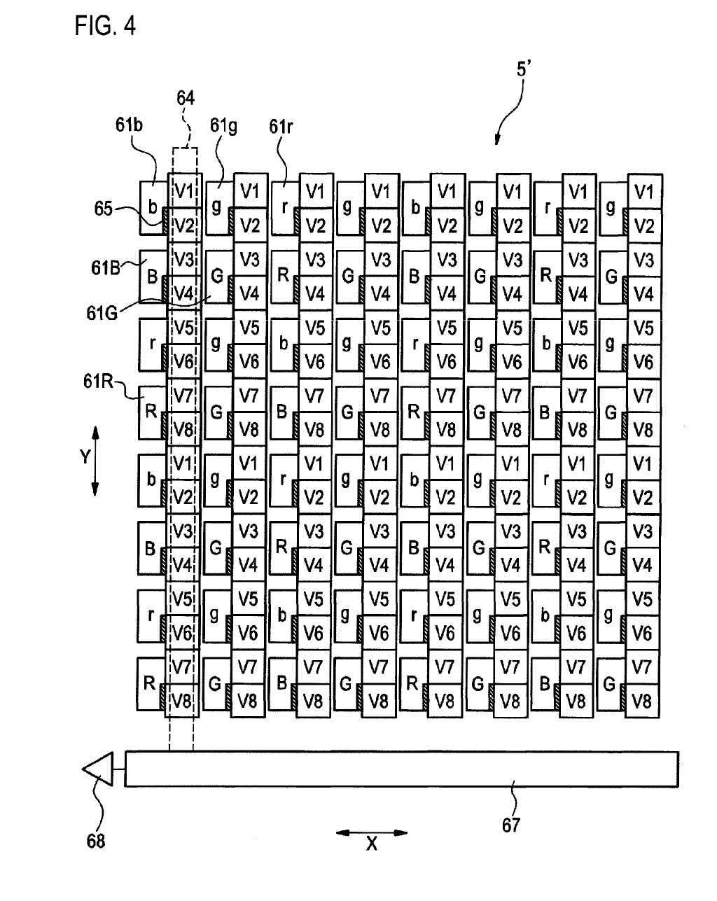

FIG. 4 is a plan view schematically another example of the solid-state imaging device provided in the digital camera shown in FIG. 1.

A solid-state imaging device 5′ includes an RGB group and an rgb group. The RGB group includes photoelectric conversion elements 61R (which is represented by ‘R’ in FIG. 4) that detects R light, photoelectric conversion elements 61G (which is represented by ‘G’ in FIG. 4) that detects G light, and photoelectric conversion elements 61B (which is represented by ‘B’ in FIG. 4) that detects B light. The photoelectric conversion elements 61R, 61G, 61B are arranged in a lattice shape on a semiconductor substrate in a row direction X and in a column direction Y that is perpendicular to the row direction X. The rgb group includes photoelectric conversion elements 61r (which is represented by ‘r’ in FIG. 4) that detects R light, photoelectric conversion elements 61g (which is represented by ‘g’ in FIG. 4) that detects G light, and photoelectric conversion elements 61b (which is represented by ‘b’ in FIG. 4) that detects B light. The photoelectric conversion elements 61r, 61g, 61b are arranged in a lattice shape on the semiconductor substrate in the row direction X and in the column direction Y being perpendicular to the row direction X. The RGB group and the rgb group are shifted in the column direction Y from each other by about half of the pitch in the column direction Y between the photoelectric conversion elements of each group.

The photoelectric conversion elements of the RGB group and the photoelectric conversion elements of the rgb group have the same structure, but the imaging device driving section 10 controls the exposure time of the photoelectric conversion elements of the RGB group and the exposure time of the photoelectric conversion elements of the rgb group to be different from each other. In this embodiment, the exposure time of the photoelectric conversion elements of the rgb group are set to be shorter than that of the photoelectric conversion elements of the RGB group.

The photoelectric conversion elements of the solid-state imaging device 5′ are arranged so that a bgrg photoelectric conversion element row, a BGRG photoelectric conversion element row, an rgbg photoelectric conversion element row and an RGBG photoelectric conversion element row are repeatedly arranged in the column direction Y in this order. In the bgrg photoelectric conversion element row including the photoelectric conversion elements 61b, the photoelectric conversion elements 61g, and the photoelectric conversion elements 61r, a set of the photoelectric conversion element 61b, the photoelectric conversion element 61g, the photoelectric conversion element 61r, and the photoelectric conversion element 61g arranged in this order in the row direction X is repeatedly arranged in the row direction X. In the BGRG photoelectric conversion element row including the photoelectric conversion elements 61B, the photoelectric conversion elements 61G, and the photoelectric conversion elements 61R, a set of the photoelectric conversion element 61B, the photoelectric conversion element 61G, the photoelectric conversion element 61R, and the photoelectric conversion element 61G arranged in this order in the row direction X is repeatedly arranged in the row direction X. In the rgbg photoelectric conversion element row including the photoelectric conversion elements 61b, the photoelectric conversion elements 61g, and the photoelectric conversion elements 61r, a set of the photoelectric conversion element 61r, the photoelectric conversion element 61g, the photoelectric conversion element 61b, and the photoelectric conversion element 61g arranged in this order in the row direction X is repeatedly arranged in the row direction X. In the RGBG photoelectric conversion element row including the photoelectric conversion elements 61B, the photoelectric conversion elements 61G, and the photoelectric conversion elements 61R, a set of the photoelectric conversion element 61R, the photoelectric conversion element 61G, the photoelectric conversion element 61B, and the photoelectric conversion element 61G arranged in this order in the row direction X is repeatedly arranged in the row direction X.

Vertical charge transfer paths 64 (some of them are shown in FIG. 4) are formed on the right side of the respective photoelectric conversion element columns, which are formed of the photoelectric conversion elements arranged in the column direction Y, so as to correspond to the respective photoelectric conversion element columns. Each vertical charge transfer path 64 transfers in the column direction Y charges stored in the photoelectric conversion elements constituting the corresponding photoelectric conversion element column. The vertical charge transfer paths 64 are formed of, for example, n-type impurities injected into a p well layer that is formed on an n-type silicon substrate.

A charge read-out section 65 that reads out the charge generated in each photoelectric conversion element to the vertical charge transfer path 64 is provided between each photoelectric conversion element and the corresponding vertical change transfer path 64. For example, the charge read-out section 65 is formed of a portion of the p well layer that is formed on an n-type silicon substrate. The charge read-out sections 65 are provided in the same position with respect to the photoelectric conversion elements.

Transfer electrodes V1 to V8 are formed above the vertical charge transfer paths 64. The imaging device driving section 10 applies to the transfer electrodes V1 to V8 8-phase transfer pulses for controlling the transfer of the charges read out to the vertical charge transfer paths 64. A transfer pulse φV1 is applied to the transfer electrode V1, a transfer pulse φV2 is applied to the transfer electrode V2, a transfer pulse φV3 is applied to the transfer electrode V3, a transfer pulse φV4 is applied to the transfer electrode V4, a transfer pulse φV5 is applied to the transfer electrode V5, a transfer pulse φV6 is applied to the transfer electrode V6, a transfer pulse φV7 is applied to the transfer electrode V7, and a transfer pulse φV8 is applied to the transfer electrode V8.

The transfer electrodes V1 and V2 are provided so as to correspond to the photoelectric conversion elements of the bgrg photoelectric conversion element rows. The transfer electrodes V2 are formed so as to cover the charge read-out sections 65 corresponding to the photoelectric conversion elements of the bgrg photoelectric conversion element row. When a readout pulse is applied to the transfer electrodes V2, the charges stored in the photoelectric conversion elements of the bgrg photoelectric conversion element rows are read out to the vertical charge transfer paths 64 that are provided on the right side of the photoelectric conversion elements.

The transfer electrodes V3 and V4 are provided so as to correspond to the photoelectric conversion elements of the BGRG photoelectric conversion element rows. The transfer electrodes V4 are formed so as to cover the charge read-out sections 65 corresponding to the photoelectric conversion elements of the BGRG photoelectric conversion element rows. When a readout pulse is applied to the transfer electrodes V4, the charges stored in each of the photoelectric conversion elements of the BGRG photoelectric conversion element rows are read out to the vertical charge transfer paths 64 that are provided on the right side of the photoelectric conversion elements.

The transfer electrodes V5 and V6 are provided so as to correspond to the photoelectric conversion elements of the rgbg photoelectric conversion element rows. The transfer electrodes V6 are formed so as to cover the charge read-out sections 65 corresponding to the photoelectric conversion elements of the rgbg photoelectric conversion element rows. When a readout pulse is applied to the transfer electrodes V6, the charges stored in the photoelectric conversion elements of the rgbg photoelectric conversion element rows are read out to the vertical charge transfer paths 64 that are provided on the right side of the photoelectric conversion elements.

The transfer electrodes V7 and V8 are provided so as to correspond to the photoelectric conversion elements of the RGBG photoelectric conversion element rows. The transfer electrodes V8 are formed so as to cover the charge read-out sections 65 corresponding to the photoelectric conversion elements of the RGBG photoelectric conversion element rows. When a readout pulse is applied to the transfer electrodes V8, the charges stored in the photoelectric conversion elements of the RGBG photoelectric conversion element rows to the vertical charge transfer paths 64 that are provided on the right side of the photoelectric conversion elements.

A horizontal charge transfer path 67 that transfers the charges transmitted from the vertical charge transfer paths 64 in the row direction X is connected to the vertical charge transfer paths 64. An output amplifier 68 that converts the charges transferred from the horizontal charge transfer path 67 into voltage signals and outputs the voltage signals is connected to the horizontal charge transfer path 67.

Next, the imaging operation of the digital camera having the above-mentioned structure will be described.

When a shutter button in the operation section 14 is pressed halfway, the system control section 11 performs the auto exposure (AE) process and the auto focusing (AF) process to measure a dynamic range required to capture an image of a subject. The system control section 11 determines the exposure time of the photoelectric conversion elements 61R, 61G, and 61B and the exposure time of the photoelectric conversion elements 61r, 61g, and 61b based on the measured dynamic range, and controls the imaging device driving section 10 to capture an image for the determined exposure time.

When, during the period for which a mechanical shutter (not shown) provided in the digital camera is opened, the imaging device driving section 10 stops supply of an electronic shutter pulse (SUB pulse) so as to open an electronic shutter, the exposure period of the photoelectric conversion elements 61R, 61G, and 61B starts. When the exposure period starts, a low-level (VL) transfer pulse is applied from the imaging device driving section 10 to the transfer electrodes V1 to V8.

Immediately before the exposure start timing of the photoelectric conversion elements 61r, 61g, and 61b, the imaging device driving section 10 controls the transfer pulse, which is applied to the transfer electrodes V1 to V8, to be a middle level (VM). Then, at the exposure start timing of the photoelectric conversion elements 61r, 61g, and 61b, the imaging device driving section 10 applies a high-level (VH) readout pulse to the transfer electrodes V2 and V6 and applies a low-level suppression pulse to the transfer electrodes V4 and V8, so as to read out the charges stored in the photoelectric conversion elements 61r, 61g, and 61b to the vertical charge transfer path 64 through the charge read-out sections 65. Upon stop of the readout pulse, the imaging device driving section 10 starts the exposure period of the photoelectric conversion elements 61r, 61g, and 61b.

After applying the readout pulse and the suppression pulse, the imaging device driving section 10 returns the transfer pulses φV2, φV4, φV6, and φV8 to the middle level VM, and then changes the transfer pulses other than the transfer pulses φV2 and φV6 to the low level VL. When the electronic shutter is closed and the exposure time of the photoelectric conversion element ends, the imaging device driving section 10 controls the transfer pulses to sweep unnecessary charges remaining in the vertical charge transfer paths 64 at a high speed. After the sweep of the charges is completed, the imaging device driving section 10 applies the readout pulse to the transfer electrodes V4 and V8 and applies the suppression pulse to the transfer electrodes V2 and V6, so as to read out the charges stored in the photoelectric conversion elements 61R, 61G, and 61B to the vertical charge transfer paths 64. Thereafter, the imaging device driving section 10 controls the transfer pulses to transfer the read charges to the output amplifier 68 through the horizontal charge transfer path 67. In this way, signals corresponding to the charges stored in the photoelectric conversion elements 61R, 61G, and 61B are output from the solid-state imaging device 5′.

Next, the imaging device driving section 10 controls the transfer pulses to sweep unnecessary charges remaining in the vertical charge transfer path 64 at a high speed. After the sweep of the charge is completed, the imaging device driving section 10 applies the readout pulse to the transfer electrodes V2 and V6 and applies the suppression pulse to the transfer electrodes V4 and V8 to read out the charges stored in the photoelectric conversion elements 61r, 61g, and 61b to the vertical charge transfer paths 64. Thereafter, the imaging device driving section 10 controls the transfer pulses to transfer the read charges to the output amplifier 68 through the horizontal charge transfer path 67. In this way, signals corresponding to the charges stored in the photoelectric conversion elements 61r, 61g, and 61b are output from the solid-state imaging device 5′.

The digital signal processing section 17 generates image data based on the signals obtained from the photoelectric conversion elements 61R, 61G, and 61B, generates image data based on the signals obtained from the photoelectric conversion elements 61r, 61g, and 61b, synthesizes the two image data to generate synthesized image data in a wide dynamic range, and outputs the synthesized image data to the compression/expansion processing section 18. The compression/expansion processing section 18 compresses the synthesized image data, and the compressed synthesized image data is stored in the recording medium 21. In this way, the imaging operation is completed.

As described above, the solid-state imaging device having the structure shown in FIG. 4 can perform a similar operation to that in the first embodiment. As a result, it is possible to obtain similar effects to those achieved in the first embodiment.

### Third Embodiment

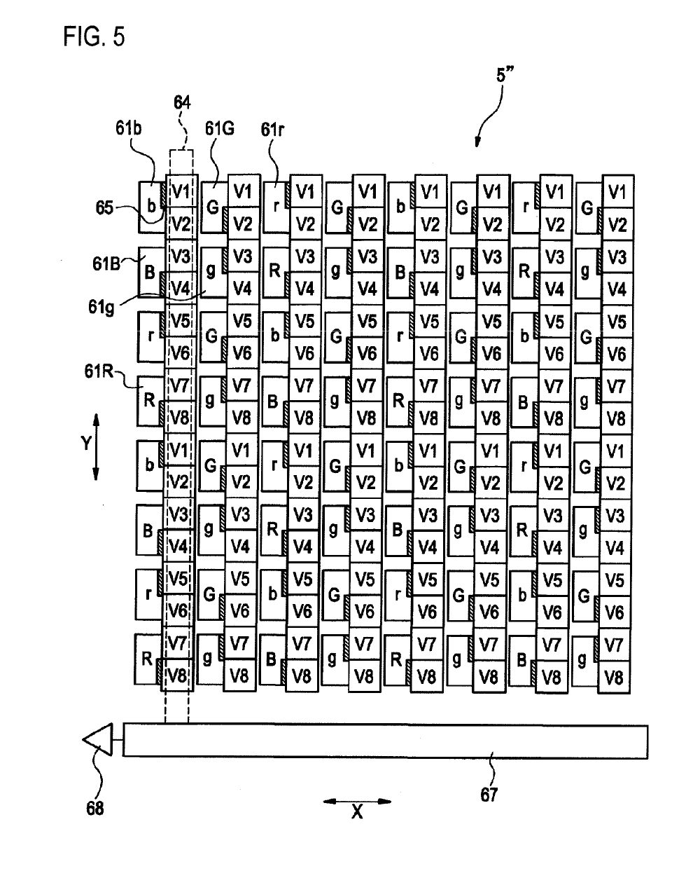

FIG. 5 is a plan view schematically illustrating still another example of the structure of the solid-state imaging device provided in the digital camera shown in FIG. 1.

A solid-state imaging device 5″ shown in FIG. 5 has a structure in which the photoelectric conversion element 61G and the photoelectric conversion element 61g adjacent to the photoelectric conversion element 61G on the opposite side of the horizontal charge transfer path 67 are reversed in the solid-state imaging device shown in FIG. 4. Of the charge read-out sections 65 provided so as to correspond to the photoelectric conversion elements 61G shown in FIG. 4, the positions of the charge read-out sections 65 below the transfer electrode V4 are changed to positions below the transfer electrodes V3 adjacent to the transfer electrodes V4, and the positions of the charge read-out sections 65 below the transfer electrodes V8 are changes to positions below the transfer electrodes V7 adjacent to the transfer electrodes V8. Furthermore, the positions of the charge read-out sections 65 provided so as to correspond to the photoelectric conversion elements 61r and 61b shown in FIG. 4 are changed from below the transfer electrodes V2 to below the transfer electrodes V1 adjacent to the transfer electrodes V2, and are changed from below the transfer electrodes V6 to below the transfer electrodes V5 adjacent to the transfer electrodes V6.

The transfer electrodes V1 and V5 are formed so as to cover the charge read-out sections 65 corresponding to the photoelectric conversion elements 61r and 61b. Therefore, when a readout pulse is applied to the transfer electrodes V1 and V5, the charges stored in the photoelectric conversion elements 61r and 61b are read out to the vertical charge transfer paths 64 that are provided on the right side of the photoelectric conversion elements.

The transfer electrodes V3 and V7 are formed so as to cover the charge read-out sections 65 corresponding to the photoelectric conversion elements 61g. Therefore, when a readout pulse is applied to the transfer electrodes V3 and V7, the charges stored in the photoelectric conversion elements 61g are read out to the vertical charge transfer paths 64 that are provided on the right side of the photoelectric conversion elements.

The transfer electrodes V2 and V6 are formed so as to cover the charge read-out sections 65 corresponding to the photoelectric conversion elements 61G. Therefore, when a readout pulse is applied to the transfer electrodes V2 and V6, the charges stored in the photoelectric conversion elements 61G are read out to the vertical charge transfer paths 64 that are provided on the right side of the photoelectric conversion elements.

The transfer electrodes V4 and V8 are formed so as to cover the charge read-out sections 65 corresponding to the photoelectric conversion elements 61R and 61B. Therefore, when a readout pulse is applied to the transfer electrodes V4 and V8, the charges stored in the photoelectric conversion elements 61R and 61B are read out to the vertical charge transfer paths 64 that are provided on the right side of the photoelectric conversion elements.

Next, the imaging operation of the digital camera shown in FIG. 1 having the solid-state imaging device 5″ will be described.

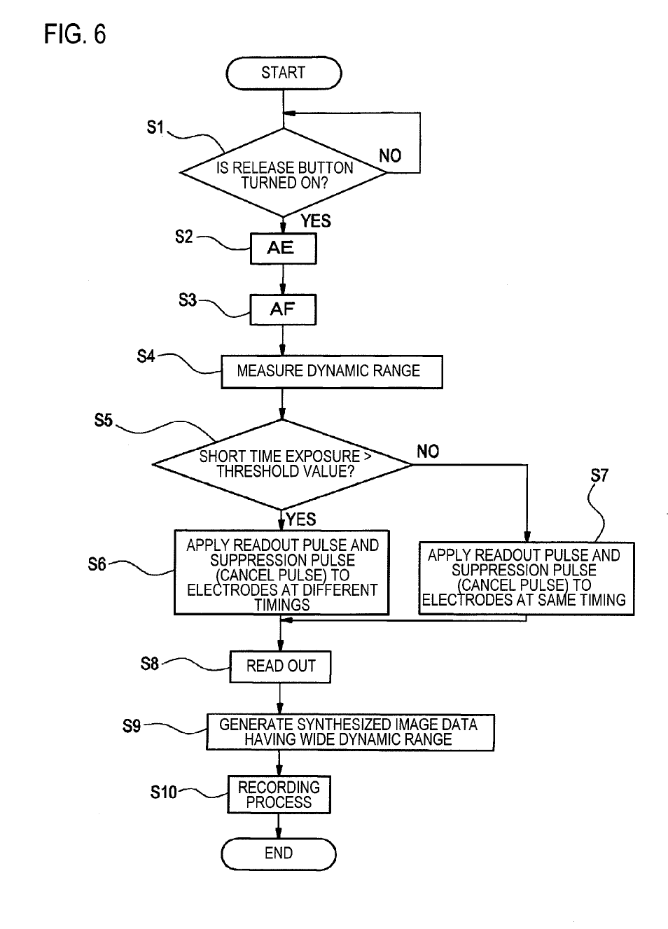

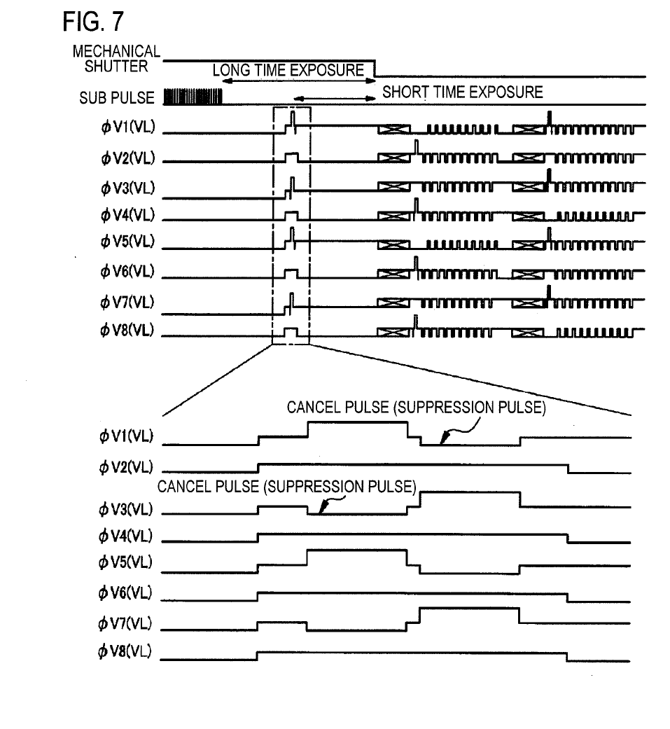

FIG. 6 is a flowchart illustrating the imaging operation of the digital camera according to the third embodiment. FIG. 7 is a timing chart of transfer pulses during the imaging operation of the digital camera according to the third embodiment.

When a shutter button in the operation section 14 is pressed halfway (Step S1), the system control section 11 performs the auto exposure (AE) process (Step S2) and the auto focusing (AF) process (Step S3) to measure a dynamic range required to capture an image of a subject (Step S4). The system control section 11 determines the exposure time of the photoelectric conversion elements 61R, 61G, and 61B and the exposure time of the photoelectric conversion elements 61r, 61g, and 61b based on the measured dynamic range.

Then, the system control section 11 determines as to whether or not the exposure time of the photoelectric conversion elements 61r, 61g, and 61b is longer than a threshold value (Step S5). If the exposure time of the photoelectric conversion elements 61r, 61g, and 61b is longer than the threshold value (Step S5: YES), the system control section 11 controls the imaging device driving section 10 to perform a time division read-out operation of classifying the photoelectric conversion elements 61r, 61g, and 61b into two groups and applying the readout pulse and the suppression pulse to the respective groups at different timings to read out the charges stored in the photoelectric conversion elements 61r, 61g, and 61b to the vertical charge transfer paths 64 (Step S6).

Next, the time division read-out operation will be described in detail.

As shown in FIG. 7, when, during the period for which a mechanical shutter (not shown) provided in the digital camera is opened, the imaging device driving section 10 stops supply of an electronic shutter pulse (SUB pulse) and an electronic shutter is opened, the exposure period of the photoelectric conversion elements 61R, 61G, and 61B starts. When the exposure period starts, a low-level (VL) transfer pulse is applied from the imaging device driving section 10 to the transfer electrodes V1 to V8.

Immediately before the exposure start timing of the photoelectric conversion elements 61r, 61g, and 61b, the imaging device driving section 10 applies a middle-level (VM) transfer pulse to the transfer electrodes V1 to V8. Then, at the exposure start timing of the photoelectric conversion elements 61r, 61g, and 61b, the imaging device driving section 10 applies a high-level (VH) readout pulse to the transfer electrodes V1 and V5 and applies a suppression pulse to the transfer electrodes V3 and V7 so as to read out the charges stored in the photoelectric conversion elements 61r and 61b to the vertical charge transfer paths 64 through the charge read-out sections 65. Then, the imaging device driving section 10 returns the transfer pulses φV1 to φV8 to the middle level VM. Then, the imaging device driving section 10 applies the high-level (VH) readout pulse to the transfer electrodes V3 and V7 and applies the suppression pulse to the transfer electrodes V1 and V5 so as to read out the charges stored in the photoelectric conversion elements 61g to the vertical charge transfer paths 64 through the charge read-out sections 65.

In this way, the time division read-out operation is completed.

Returning to description on the operation shown in FIG. 6, if the exposure time of the photoelectric conversion elements 61r, 61g, and 61b is shorter than the threshold value (Step S5: NO), the system control section 11 controls the imaging device driving section 10 to perform a concurrent read-out operation of concurrently applying the readout pulse to the transfer electrodes above the charge read-out sections 65 corresponding to all the photoelectric conversion elements of the rgb group and applying the suppression pulse to at least a part of the transfer electrodes other than the transfer electrodes to which the readout pulse is applied, thereby reading out the charges stored in the photoelectric conversion elements 61r, 61g, and 61b to the charge transfer path 64 (Step S7).

The concurrent read-out operation will be described in detail below.

When, during the period for which the mechanical shutter (not shown) provided in the digital camera is opened, the imaging device driving section 10 stops the supply of the electronic shutter pulse (SUB pulse) and the electronic shutter is opened, the exposure period of the photoelectric conversion elements 61R, 61G, and 61B starts. When the exposure period starts, the low-level (VL) transfer pulse is applied from the imaging device driving section 10 to the transfer electrodes V1 to V8.

Immediately before the exposure start timing of the photoelectric conversion elements 61r, 61g, and 61b, the imaging device driving section 10 applies the middle-level (VM) transfer pulse to the transfer electrodes V1 to V8. Then, at the exposure start timing of the photoelectric conversion elements 61r, 61g, and 61b, the imaging device driving section 10 applies the high-level (VH) readout pulse to the transfer electrodes V1, V3, V5, and V7 and applies the suppression pulse to the transfer electrodes V2, V4, V6, and V8, so as to read out the charges stored in the photoelectric conversion elements 61r, 61g, and 61b to the vertical charge transfer path 64 through the charge read-out sections 65.

In this way, the concurrent read-out operation is completed.

When Step S6 or S7 ends, the electronic shutter is closed, and the exposure time of the photoelectric conversion elements ends, the imaging device driving section 10 controls the transfer pulses to sweep unnecessary charges remaining in the vertical charge transfer path 64 at a high speed. After the sweep of the charge is completed, the imaging device driving section 10 applies the readout pulse to the transfer electrodes V2 and V6 and applies the suppression pulse to the transfer electrodes V4 and V8 to read out the charges stored in the photoelectric conversion elements 61G to the vertical charge transfer paths 64. Then, the imaging device driving section 10 returns the transfer pulses φV1 to φV8 to the middle level VM. Then, the imaging device driving section 10 applies the high-level (VH) readout pulse to the transfer electrodes V4 and V8, and applies the suppression pulse to the transfer electrodes V2 and V6 to read out the charges stored in the photoelectric conversion elements 61R and 61B to the vertical charge transfer paths 64 through the charge read-out sections 65. Thereafter, the imaging device driving section 10 controls the transfer pulses to transfer the read charges to the output amplifier 68 through the horizontal charge transfer path 67. In this way, signals corresponding to the charges stored in the photoelectric conversion elements 61R, 61G, and 61B are output from the solid-state imaging device 5″.

Then, the imaging device driving section 10 controls the transfer pulses to sweep unnecessary charges remaining in the vertical charge transfer path 64 at a high speed. After the sweep of the charge is completed, the imaging device driving section 10 applies the readout pulse to the transfer electrodes V1 and V5 and applies the suppression pulse to the transfer electrodes V3 and V7, so as to read out the charges stored in the photoelectric conversion elements 61r and 61b to the vertical charge transfer paths 64. Then, the imaging device driving section 10 returns the transfer pulses φV1 to φV8 to the middle level VM. Then, the imaging device driving section 10 applies the high-level (VH) readout pulse to the transfer electrodes V3 and V7, and applies the suppression pulse to the transfer electrodes V1 and V5, so as to read out the charges stored in the photoelectric conversion elements 61g to the vertical charge transfer paths 64 through the charge read-out sections 65. Thereafter, the imaging device driving section 10 controls the transfer pulses to transfer the read charges to the output amplifier 68 through the horizontal charge transfer path 67. In this way, signals corresponding to the charges stored in the photoelectric conversion elements 61r, 61g, and 61b are output from the solid-state imaging device 5″ (Step S8).

The digital signal processing section 17 generates image data based on the signals obtained from the photoelectric conversion elements 61R, 61G, and 61B, generates image data based on the signals obtained from the photoelectric conversion elements 61r, 61g, and 61b, synthesizes the two image data to generate synthesized image data in a wide dynamic range (Step S9), and outputs the synthesized image data to the compression/expansion processing section 18. The compression/expansion processing section 18 compresses the synthesized image data, and the compressed synthesized image data is stored in the recording medium 21 (Step S10). In this way, the imaging operation is completed.

When the suppression pulse described in the first embodiment is applied to any transfer electrodes other than the transfer electrodes to which the readout pulse is applied, its advantage can be achieved. However, when the suppression pulse is applied to a transfer electrode adjacent to the transfer electrode to which the readout pulse is applied, a high-voltage transfer electrode and a low-voltage transfer electrode are adjacent to each other. In this case, electrode may be damaged due to a difference in voltage between the two adjacent transfer electrodes, and an amount of dark current in the photoelectric conversion elements 61r, 61g, and 61b increases in proportion to the number of times the electrodes are damaged. As a result, the reliability of the solid-state imaging device may be lowered.

For this reason, in order to reduce the dark current and improve the reliability, it is important not to apply the suppression pulse to transfer electrodes adjacent to the transfer electrode to which the readout pulse is applied.

In this embodiment, the above-mentioned time division read-out operation is performed in order to improve the reliability. The solid-state imaging device 5″ according to this embodiment is configured so as to control (i) the read-out of charges from the photoelectric conversion elements 61r and 61b, and (ii) the read-out of charges from the photoelectric conversion elements 61g independently from each other. Therefore, when the readout pulse for controlling the exposure time of the photoelectric conversion elements 61r, 61g, and 61b is applied, it is possible to apply the suppression pulse to transfer electrodes other than the transfer electrodes adjacent to the transfer electrode to which the readout pulse is applied. As a result, it is possible to prevent the accumulation of the electrode damage and prevent the generation of the dark current.

However, when the time division read-out operation is performed, there is a small difference in exposure time between the photoelectric conversion elements 61r and 61b and the photoelectric conversion element 61g. The difference in exposure time is allowable if the exposure time of the photoelectric conversion elements 61r, 61b, and 61g, which is determined by the system control section 11, is sufficiently long. However, if the exposure time of the photoelectric conversion elements 61r, 61b, and 61g is short, an image quality is significantly deteriorated.

As described above, the time division read-out operation can reduce the dark current, but it may cause the deterioration of the image quality due to the difference in exposure time between the photoelectric conversion elements 61r and 61b and the photoelectric conversion element 61g. Meanwhile, in the concurrent read-out operation, since the suppression pulse is applied to the transfer electrodes adjacent to the transfer electrode to which the readout pulse is applied, the dark current is likely to occur due to electrode damage. However, since the difference in exposure time does not occur, the concurrent read-out operation is less likely to deteriorate the image quality.

In the digital camera according to this embodiment, in order to perform the concurrent read-out operation that causes an increase in electrode damage as little as possible, when it is determined that the exposure time of the photoelectric conversion elements 61r, 61b, and 61g is longer than the threshold value and the influence of the difference in exposure time is allowable, the imaging device driving section 10 performs the time division read-out operation. Only when it is determined that the exposure time of the photoelectric conversion elements 61r, 61b, and 61g is equal to or shorter than the threshold value and the influence of the difference in exposure time is not allowable, the imaging device driving section 10 performs the concurrent read-out operation.

That is, the concurrent read-out operation is performed only when the image quality is significantly deteriorated due to the difference in exposure time, and otherwise the time division read-out operation is performed. In this way, it is possible to prevent the accumulation of electrode damage while fully reading out the charges for the exposure time control. Therefore, it is possible to prevent an increase in dark current due to the electrode damage.

However, during the charge read-out operation after the exposure period ends, even the time division read-out operation has no effect on the image quality. Therefore, as described above, during the charge read-out operation after the exposure period ends, the time division read-out operation is performed at all times in order to prevent the generation of dark current.

The threshold value may be an upper limit of the exposure time of the photoelectric conversion elements 61r, 61g, and 61b at which the deterioration of image quality due to the difference in exposure time is not allowable.

In FIG. 7, the middle-level (VM) transfer pulse is applied to the transfer electrodes V1 to V8 and then, the readout pulse is applied thereto immediately before the exposure of the photoelectric conversion elements 61r, 61g, and 61b starts. However, the middle-level (VM) transfer pulse may be applied to the transfer electrodes to which neither the readout pulse nor the suppression pulse is applied concurrently with the applying of the readout pulse. In this case, during the entire period from the exposure start time of the photoelectric conversion elements 61R, 61G, and 61B to the exposure start time of the photoelectric conversion elements 61r, 61g, and 61b, it is possible to apply the low-level (VL) transfer pulse to the transfer electrodes V1 to V8. Therefore, it is possible to improve the effect of preventing white defects.

### Fourth Embodiment

The structure of a digital camera according to a fourth embodiment is substantially similar to that of the digital camera according to the third embodiment except a driving method of the imaging device driving section 10. The digital camera according to this embodiment performs a concurrent read-out operation without the suppression pulse, instead of performing the concurrent read-out operation in step S7 shown in FIG. 6. The concurrent read-out operation without the suppression pulse concurrently applies a readout pulse to the transfer electrodes above the charge read-out sections 65 corresponding to all the photoelectric conversion elements of the rgb group without applying the suppression pulse, so as to read out the charges stored in the photoelectric conversion elements 61r, 61g, and 61b to the vertical charge transfer paths 64.

Next, the method of driving the solid-state imaging device according to the fourth embodiment will be described.

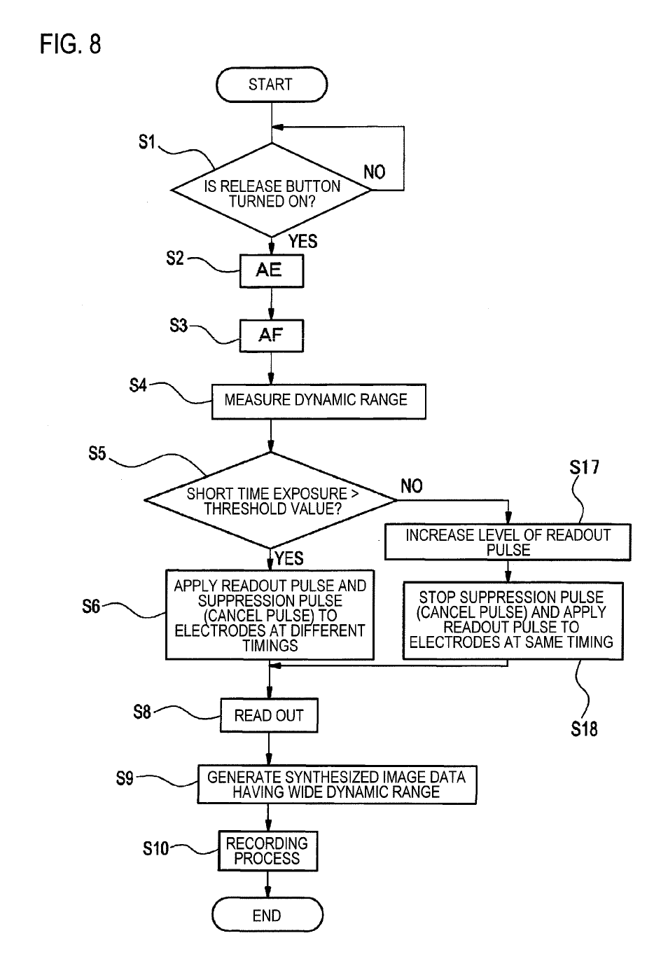

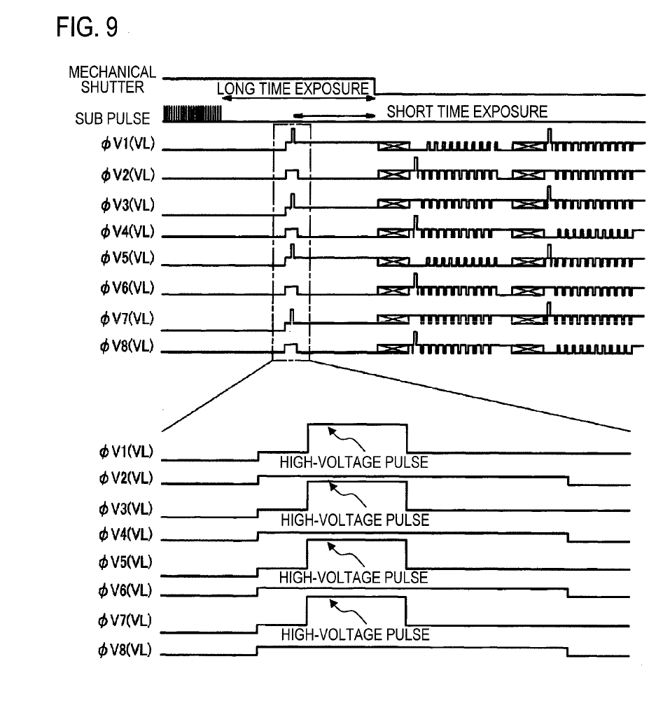

FIG. 8 is a flowchart of the imaging operation of the digital camera according to the fourth embodiment. FIG. 9 is a timing chart of transfer pulses during the imaging operation of the digital camera according to the fourth embodiment (when the concurrent read-out operation without the suppression pulse is performed). In FIG. 8, the same steps as those in FIG. 6 are denoted by the same reference numerals.

If the exposure time of the photoelectric conversion elements 61r, 61g, and 61b is shorter than the threshold value (Step S5: NO), the system control section 11 instructs to increase a level of the readout pulse (Step S17) and then controls the imaging device driving section 10 to perform the concurrent read-out operation without the suppression pulse (Step S18). After the concurrent read-out operation without the suppression pulse is completed, the system control section 11 returns to step S8.

Next, the concurrent read-out operation without the suppression pulse will be described in detail.

As shown in FIG. 9, when, during the period for which the mechanical shutter (not shown) provided in the digital camera is opened, the imaging device driving section 10 stops the supply of the electronic shutter pulse (SUB pulse) to open the electronic shutter, the exposure period of the photoelectric conversion elements 61R, 61G, and 61B starts. When the exposure period starts, the low-level (VL) transfer pulse is applied from the imaging device driving section 10 to the transfer electrodes V1 to V8.

Immediately before the exposure start timing of the photoelectric conversion elements 61r, 61g, and 61b, the imaging device driving section 10 applies the middle-level (VM) transfer pulse to the transfer electrodes V1 to V8. Then, at the exposure start timing of the photoelectric conversion elements 61r, 61g, and 61b, the imaging device driving section 10 applies a high-level readout pulse (which is higher than the readout pulse applied during the time division read-out operation (for example, 18 or 19 V)) to the transfer electrodes V1, V3, V5, and V7 so as to read out the charges stored in the photoelectric conversion elements 61r, 61g, and 61b to the vertical charge transfer paths 64 through the charge read-out sections 65.

In this way, the concurrent read-out operation without the suppression pulse is completed.

The suppression pulse described in the first embodiment is used to fully read out the charges from the photoelectric conversion elements. However, if the level of the readout pulse is sufficiently high, the charges can be fully read out even without the suppression pulse. Therefore, this embodiment adopts the concurrent read-out operation without the suppression pulse that can fully read out the charges from the photoelectric conversion elements. According to the concurrent read-out operation without the suppression pulse, it is not necessary to apply the suppression pulse, and it is possible to bring the potential of the transfer electrodes adjacent to the transfer electrodes to which the readout pulse is applied, to the ground level. Therefore, it is possible to prevent the generation of dark current due to electrode damage.

In the digital camera according to this embodiment, in order to perform the concurrent read-out operation without the suppression pulse, which applies the high-voltage readout pulse, as little as possible (in order to reduce power consumption), when it is determined that the exposure time of the photoelectric conversion elements 61r, 61b, and 61g is longer than a threshold value and the influence of the difference in exposure time is allowable, the imaging device driving section 10 performs the time division read-out operation. Only when it is determined that the exposure time of the photoelectric conversion elements 61r, 61b, and 61g is equal to or shorter than the threshold value and the influence of the difference in exposure time is not allowable, the imaging device driving section 10 performs the concurrent read-out operation without the suppression pulse.

That is, the concurrent read-out operation without the suppression pulse is performed only when image quality is significantly deteriorated due to the difference in exposure time and, otherwise the time division read-out operation is performed. In this way, it is possible to prevent the accumulation of electrode damage while fully reading out the charges for the exposure time control. Therefore, it is possible to prevent an increase in dark current due to the electrode damage.

A level of the readout pulse applied during the concurrent read-out operation without the suppression pulse may be set to a level at which the charges can be fully read out from the photoelectric conversion elements. For example, the readout pulse may have a level that is sufficiently lower than a value (+22 V) obtained by adding the absolute values of VH and VL. Therefore, a difference in potential between the transfer electrode to which the readout pulse is applied and an adjacent transfer electrode thereof can be made lower than that in the concurrent read-out operation. As a result, it is possible to reduce electrode damage and prevent an increase in dark current.

The suppression pulse may not be applied in step S6 shown in FIG. 8. When the applying of the suppression pulse is omitted in step S6 shown in FIG. 8 and the readout pulse is applied plural times, it is possible to reduce the number of transfer electrodes to which the readout pulse is applied and which are arranged around the photoelectric conversion elements from which charge will be read out, as compared to the case where the readout pulse is applied only once. As a result, a fluctuation of a potential of the photoelectric conversion elements is reduced, and a fluctuation of the effective voltage of the readout pulse is reduced. Therefore, even if no suppression pulse is applied, it is possible to fully read out the charges from the photoelectric conversion elements. In addition, if the applying of the suppression pulse in step 6 is omitted and if an image quality becomes not allowable due to the difference in exposure time, performing the process of step S18 without performing the process of step S6 is technically significant in terms of improvement of the image quality.

In the example shown in FIG. 9, the middle-level (VM) transfer pulse is applied to the transfer electrodes V1 to V8 and then, the readout pulse is applied thereto immediately before the exposure of the photoelectric conversion elements 61r, 61g, and 61b starts. However, the middle-level (VM) transfer pulse may be applied to the transfer electrodes to which no readout pulse is applied, concurrently with the applying of the readout pulse. In this case, during the entire period from the exposure start time of the photoelectric conversion elements 61R, 61G, and 61B to the exposure start time of the photoelectric conversion elements 61r, 61g, and 61b, it is possible to apply the low-level (VL) transfer pulse to the transfer electrodes V1 to V8. Therefore, it is possible to improve the effect of preventing white defects.

What is claimed is:

1. An imaging apparatus comprising:
a solid-state imaging device; and
a driving unit that drives the solid-state imaging device, wherein
the solid-state imaging device includes:
a plurality of photoelectric conversion elements that are two-dimensionally arranged on a semiconductor substrate in a specific direction and a direction that is orthogonal to the specific direction,
a plurality of charge transfer paths that are provided so as to correspond to photoelectric conversion element columns, each including the photoelectric conversion elements arranged in the specific direction, the charge transfer paths that transfer in the specific direction charges generated in the plurality of photoelectric conversion elements, and
transfer electrodes that are provided above the charge transfer paths and are arranged along the specific direction,
the transfer electrodes include first transfer electrodes that are provided to correspond to the respective photoelectric conversion elements constituting the photoelectric conversion element column, the first transfer electrodes that control reading out of the charges from the photoelectric conversion elements to the charge transfer paths and the transferring of the charges in the charge transfer path,
the plurality of photoelectric conversion elements include first photoelectric conversion elements and second photoelectric conversion elements,
an exposure time of the second photoelectric conversion elements is shorter than that of the first photoelectric conversion elements, and
during the exposure period of the first photoelectric conversion elements, the driving unit performs a driving operation including
applying, to the first transfer electrodes corresponding to the second photoelectric conversion elements, a readout pulse for reading out the charges stored in the photoelectric conversion elements to the charge transfer paths, and
applying, to at least a part of the transfer electrodes other than the transfer electrode to which the readout pulse is applied, a suppression pulse that has a polarity opposite to that of the readout pulse and prevents potentials of charge storage regions of the photoelectric conversion elements from changing due to the readout pulse.

2. The imaging apparatus according to claim 1, wherein
when the exposure time of the second photoelectric conversion elements is equal to or shorter than a threshold value, the driving unit performs the driving operation, and
when the exposure time of the second photoelectric conversion elements is longer than the threshold value, the driving unit classifies the first transfer electrodes corresponding to the second photoelectric conversion elements into a plurality of groups and applies the readout pulse and the suppression pulse to the plurality of groups at different timings.

3. The imaging apparatus according to claim 1, wherein
when the exposure time of the second photoelectric conversion elements is longer than a threshold value, the driving unit classifies the first transfer electrodes corresponding to the second photoelectric conversion elements into a plurality of groups and applies the readout pulse and the suppression pulse to the plurality of groups at different timings, and
when the exposure time of the second photoelectric conversion elements is equal to or shorter than the threshold value, the driving unit stops the applying of the suppression pulse during the driving operation and sets a level of the readout pulse to be higher than that of the readout pulse, which is applied when the exposure time of the second photoelectric conversion elements is longer than the threshold value.

4. The imaging apparatus according to claim 1, wherein a timing at which it is started to apply the suppression pulse matches a timing at which it is started to apply the readout pulse.

5. The imaging apparatus according to claim 1, wherein
applicable to each transfer electrode are a first transfer pulse, which has a level that is lower than that of the readout pulse and forms a packet for storing the charge in each charge transfer path, and a second transfer pulse, which has a level that is lower than that of the first transfer pulse and forms a barrier against the packet in each charge transfer path, and
the driving unit applies the second transfer pulse to all the transfer electrodes during at least a portion of a period from a start of the exposure time of the first photoelectric conversion elements to the applying of the readout pulse.

6. An imaging apparatus comprising:
a solid-state imaging device; and
a driving unit that drives the solid-state imaging device, wherein
the solid-state imaging device includes:
a plurality of photoelectric conversion elements that are two-dimensionally arranged on a semiconductor substrate in a specific direction and a direction that is orthogonal to the specific direction,
a plurality of charge transfer paths that are provided so as to correspond to photoelectric conversion element columns, each including the photoelectric conversion elements arranged in the specific direction, the charge transfer paths that transfer in the specific direction charges generated in the plurality of photoelectric conversion elements, and
transfer electrodes that are provided above the charge transfer paths and are arranged along the specific direction,
the transfer electrodes include first transfer electrodes that are provided to correspond to the respective photoelectric conversion elements constituting the photoelectric conversion element column, the first transfer electrodes that control reading out of the charges from the photoelectric conversion elements to the charge transfer paths and the transferring of the charges in the charge transfer path,
the plurality of photoelectric conversion elements include first photoelectric conversion elements and second photoelectric conversion elements,
an exposure time of the second photoelectric conversion elements is shorter than that of the first photoelectric conversion elements,
when the exposure time of the second photoelectric conversion elements is longer than a threshold value, during the exposure period of the first photoelectric conversion elements, the driving unit classifies the first transfer electrodes corresponding to the second photoelectric conversion elements into a plurality of groups and applies a first readout pulse for reading out the charges stored in the photoelectric conversion elements to the charge transfer paths to the plurality of groups at different timings, and
when the exposure time of the second photoelectric conversion elements is equal to or shorter than the threshold value, during the exposure period of the first photoelectric conversion elements, the driving unit applies a second readout pulse having a level that is higher than that of the first readout pulse to the first transfer electrodes corresponding to the second photoelectric conversion elements.

7. The imaging apparatus according to claim 6, wherein
applicable to each transfer electrode are a first transfer pulse, which has a level that is lower than that of the readout pulse and forms a packet for storing the charge in each charge transfer path, and a second transfer pulse, which has a level that is lower than that of the first transfer pulse and forms a barrier against the packet in each charge transfer path, and
the driving unit applies the second transfer pulse to all the transfer electrodes during at least a portion of a period from a start of the exposure time of the first photoelectric conversion elements to the applying of the readout pulse.

8. A method of driving a solid-state imaging device, wherein
the solid-state imaging device includes
a plurality of photoelectric conversion elements that are two-dimensionally arranged on a semiconductor substrate in a specific direction and a direction that is orthogonal to the specific direction,
a plurality of charge transfer paths that are provided so as to correspond to photoelectric conversion element columns, each including the photoelectric conversion elements arranged in the specific direction, the charge transfer paths that transfer in the specific direction charges generated in the plurality of photoelectric conversion elements, and
transfer electrodes that are provided above the charge transfer paths and are arranged along the specific direction,
the transfer electrodes include first transfer electrodes that are provided to correspond to the respective photoelectric conversion elements constituting the photoelectric conversion element column, the first transfer electrodes that control reading out of the charges from the photoelectric conversion elements to the charge transfer paths and the transferring of the charges in the charge transfer path,
the plurality of photoelectric conversion elements include first photoelectric conversion elements and second photoelectric conversion elements, and
an exposure time of the second photoelectric conversion elements is shorter than that of the first photoelectric conversion elements,
the method comprising
during the exposure period of the first photoelectric conversion elements, applying, to the first transfer electrodes corresponding to the second photoelectric conversion elements, a readout pulse for reading out the charges stored in the photoelectric conversion elements to the charge transfer paths, and applying, to at least a part of the transfer electrodes other than the transfer electrode to which the readout pulse is applied, a suppression pulse that has a polarity opposite to that of the readout pulse and prevents potentials of charge storage regions of the photoelectric conversion elements from changing due to the readout pulse.

9. The method according to claim 8, further comprising:
comparing the exposure time of the second photoelectric conversion elements with a threshold value, wherein
when the exposure time of the second photoelectric conversion elements is equal to or shorter than the threshold value, the applying of the readout pulse and the applying of the suppression pulse are performed, and
when the exposure time of the second photoelectric conversion elements is longer than the threshold value, the first transfer electrodes corresponding to the second photoelectric conversion elements are classified into a plurality of groups, and the readout pulse and the suppression pulse are applied to the plurality of groups at different timings.

10. The method according to claim 8, further comprising:
comparing the exposure time of the second photoelectric conversion elements with a threshold value, wherein
when the exposure time of the second photoelectric conversion elements is longer than the threshold value, the first transfer electrodes corresponding to the second photoelectric conversion elements are classified into a plurality of groups, and the readout pulse and the suppression pulse are applied to the plurality of groups at different timings, and
when the exposure time of the second photoelectric conversion elements is equal to or shorter than the threshold value, the applying of the suppression pulse is stopped, and a level of the readout pulse is set to be higher than that of the readout pulse, which is applied when the exposure time of the second photoelectric conversion elements is longer than the threshold value.

11. The method according to claim 8, wherein a timing at which it is started to apply the suppression pulse matches a timing at which it is started to apply the readout pulse.

12. The method according to claim 8, wherein
applicable to each transfer electrode are a first transfer pulse, which has a level that is lower than that of the readout pulse and forms a packet for storing the charge in each charge transfer path, and a second transfer pulse, which has a level that is lower than that of the first transfer pulse and forms a barrier against the packet in each charge transfer path,
the method further comprising:
applying the second transfer pulse to all the transfer electrodes during at least a portion of a period from a start of the exposure time of the first photoelectric conversion elements to the applying of the readout pulse.

13. A method of driving a solid-state imaging device, wherein
the solid-state imaging device includes:
a plurality of photoelectric conversion elements that are two-dimensionally arranged on a semiconductor substrate in a specific direction and a direction that is orthogonal to the specific direction,
a plurality of charge transfer paths that are provided so as to correspond to photoelectric conversion element columns, each including the photoelectric conversion elements arranged in the specific direction, the charge transfer paths that transfer in the specific direction charges generated in the plurality of photoelectric conversion elements, and
transfer electrodes that are provided above the charge transfer paths and are arranged along the specific direction,
the transfer electrodes include first transfer electrodes that are provided to correspond to the respective photoelectric conversion elements constituting the photoelectric conversion element column, the first transfer electrodes that control reading out of the charges from the photoelectric conversion elements to the charge transfer paths and the transferring of the charges in the charge transfer path,
the plurality of photoelectric conversion elements include first photoelectric conversion elements and second photoelectric conversion elements,
an exposure time of the second photoelectric conversion elements is shorter than that of the first photoelectric conversion elements,
the method comprising:
comparing the exposure time of the second photoelectric conversion elements with a threshold value;
when the exposure time of the second photoelectric conversion elements is longer than the threshold value, during the exposure period of the first photoelectric conversion elements, classifying the first transfer electrodes corresponding to the second photoelectric conversion elements into a plurality of groups, and applying a first readout pulse for reading out the charges stored in the photoelectric conversion elements to the charge transfer paths to the plurality of groups at different timings; and
when the exposure time of the second photoelectric conversion elements is equal to or shorter than the threshold value, during the exposure period of the first photoelectric conversion elements, applying a second readout pulse having a level that is higher than that of the first readout pulse to the first transfer electrodes corresponding to the second photoelectric conversion elements.

14. The method according to claim 13, wherein
applicable to each transfer electrode are a first transfer pulse, which has a level that is lower than that of the readout pulse and forms a packet for storing the charge in each charge transfer path, and a second transfer pulse, which has a level that is lower than that of the first transfer pulse and forms a barrier against the packet in each charge transfer path,
the method further comprising:
applying the second transfer pulse to all the transfer electrodes during at least a portion of a period from a start of the exposure time of the first photoelectric conversion elements to the applying of the readout pulse.
